(19) United States
(12) Patent Application Publication
(10) Pub. No.: US 2014/0108505 A1
(43) Pub. Date: Apr. 17, 2014

(54) FILE SYNCHRONIZATION SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: DA-PENG LI, Shenzhen (CN); HAI-HONG LIN, Shenzhen (CN); CHUNG-I LEE, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/971,966

(22) Filed: Aug. 21, 2013

(30) Foreign Application Priority Data
Oct. 15, 2012 (CN) 2012103879454

(51) Int. Cl. H04L 29/08

(52) U.S. Cl. CPC H04L 67/06
USPC 709/203

(57) ABSTRACT

A client monitors a record list stored in a server. The client synchronizes updated files from the server to the client, in response to a determination that the record list has been updated. The server adjusts the sync interval according to times of updating the record list and one or more updating intervals of the updating the record list, and updates the task scheduler according to the adjusted sync interval.

### BACKGROUND

1. Technical Field

The embodiments of the present disclosure relate to data management technology, and particularly to a file synchronization system and method.

2. Description of Related Art

File synchronization in computing filed is used for backups, or ensuring that files in one or more computers are updated via certain rules (e.g., one-way file synchronization, or two-way file synchronization). When file synchronization intervals are too short, this wastes a lot of computing resource. Furthermore, if the interval is too long, data may be lost if the system malfunctions. Therefore, there is room for improvement in the art.

### BRIEF DESCRIPTION OF THE DRAWINGS

FIG. 1 is a block view of one embodiment of a client including a file synchronization system.

FIG. 2 is a block diagram of one embodiment of function modules of the file synchronization system included in the client in FIG. 1.

FIG. 3 is a flowchart of one embodiment of a file synchronization method.

FIG. 4 is a detailed description of step S3 in FIG. 3 of one embodiment for determining that the record list has been updated.

FIG. 5 illustrates one embodiment of a process of file synchronization between the client and a server.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

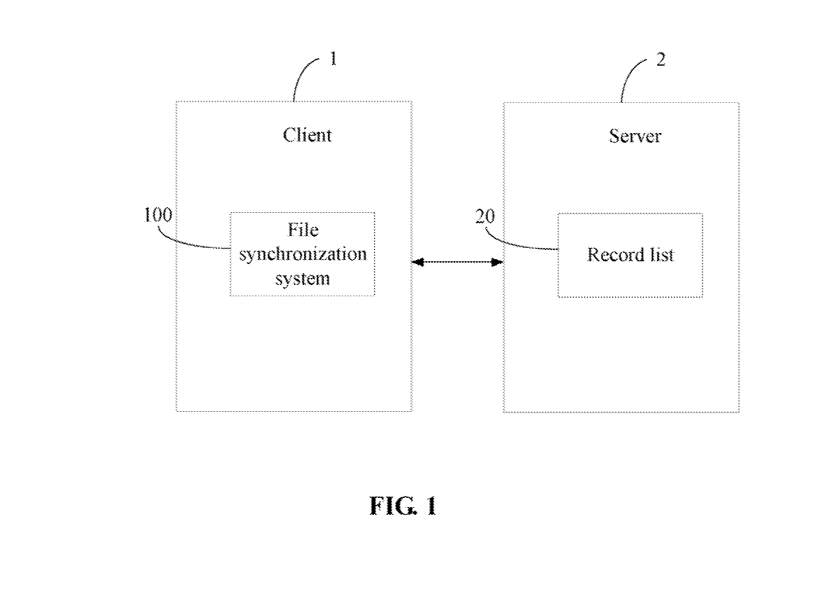

FIG. 1 is a block diagram of one embodiment of a client 1. In this embodiment, the client 1 includes a file synchronization system 100. The client 1 is connected to a server 2 via a network (e.g., the Internet or a local area network). The client 1 may provide a user interface, which is displayed on a display device of the client 1, for a user to access the server 2 and control one or more operations of the server 2. The user may input an ID and a password using an input device (e.g., a keyboard) into the user interface to access the server 2. The client 1 may be, but is not limited to, a mobile phone, a tablet computer, a personal computer or other data-processing apparatus.

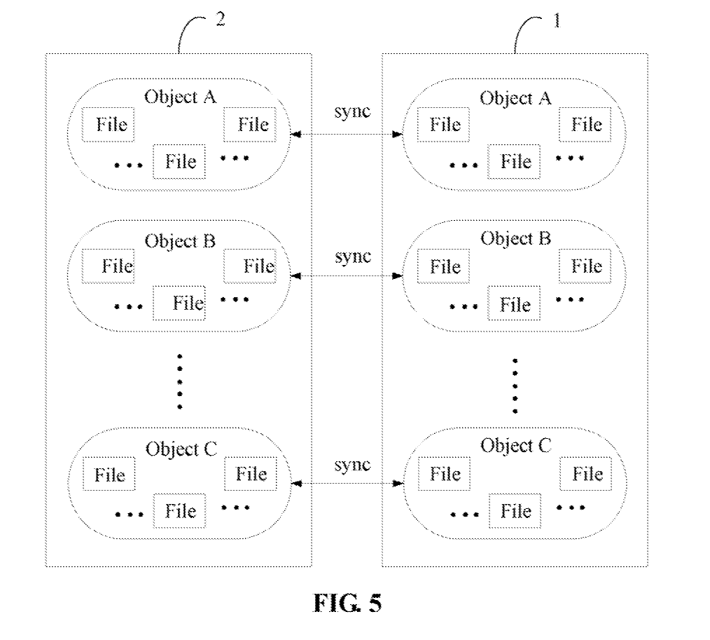

The client 1 and the server 2 store one or more objects and each object may include one or more files as shown in FIG. 5. For example, objects A, B, and C in the client 1 and the server 2 include one or more files. The one or more files may be, but are not limited to, a WORD file, a PPT file, an EXCEL file, a PDF file, a TXT file, an extensible markup language (XML) file, a hypertext markup language (HTML) file or any other files.

The server 2 also stores a record list 20. The record list 20 includes a name of each updated object in the server 1, a name of each updated file in the object, each updating time (e.g., 10:30 AM or 11: 30 AM) of updating the record list 20, one or more updating intervals of the record list 20, and times (e.g., nine times) of updating the record list 20. The record list 20 is updated when at least one file in the object is updated. In one embodiment, if a file in the object has currently been updated, the record list 20 stores the name of the updated file in the object, the name of the updated object and the updating time of the updated file. The updating time of the updated file in the object is regarded as the updating time of updating the record list 20. In other words, if the file in the object is updated in the server 2, the record list 20 is updated.

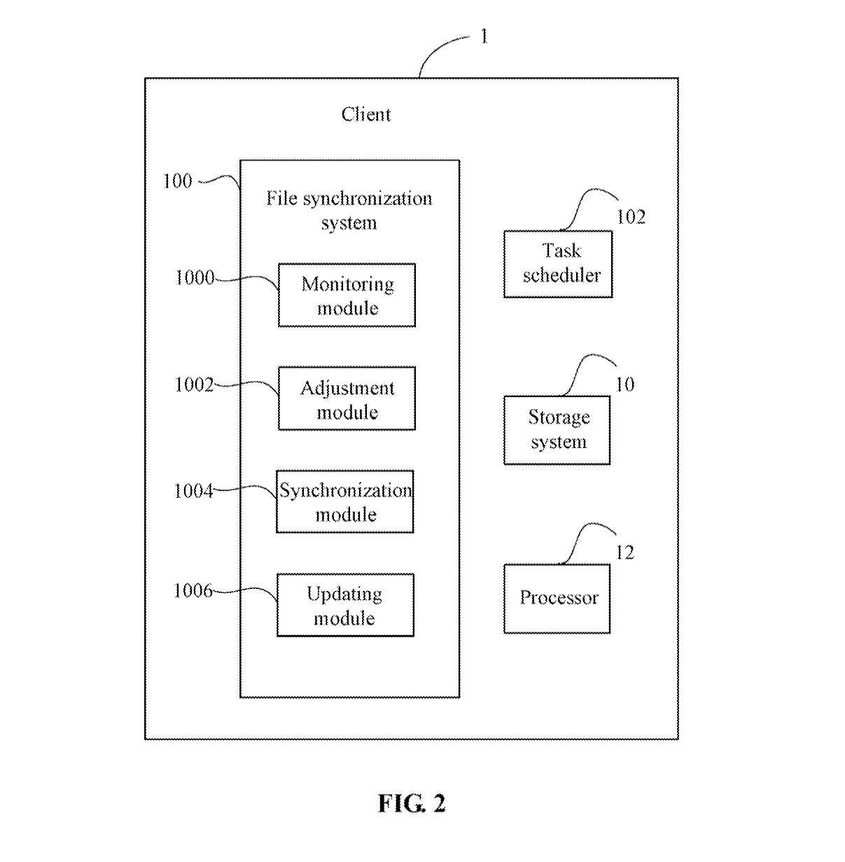

As shown in FIG. 2, the client 2 includes a task scheduler 102, and the task scheduler 102 stores a sync interval (e.g., 10 seconds) for monitoring the record list 20 stored in the server 2. The sync interval may be originally predetermined by a user, and be adjusted if needed. For example, the sync interval may be original predetermined as ten seconds, then be adjusted to twenty seconds. In other words, the record list 20 in the server 2 is monitored every ten seconds, after adjustment to the sync interval, the record list 20 in the server 2 is monitored every twenty seconds. A detailed description of how to adjust the interval is described below.

The file synchronization system 100 synchronizes files between the client 1 and the server 2. In one embodiment, the client 1 further includes a storage system 10 and at least one processor 12. The file synchronization system 100 includes a monitoring module 1000, an adjustment module 1002, a synchronization module 1004, and an updating module 1006. The modules 1000-1006 may include computerized code in the form of one or more programs that are stored in the storage system 10. The computerized code includes instructions that are executed by at least one processor 12 to provide functions for the modules 1000-1006. The storage system 10 may be a memory, such as an EPROM memory chip, hard disk drive (HDD), or flash memory stick.

The monitoring module 1000 monitors the record list 20 according to the task scheduler 102. As mentioned above, the task scheduler 102 stores a sync interval, the monitoring module 1000 monitors the record list 20 at the sync interval.

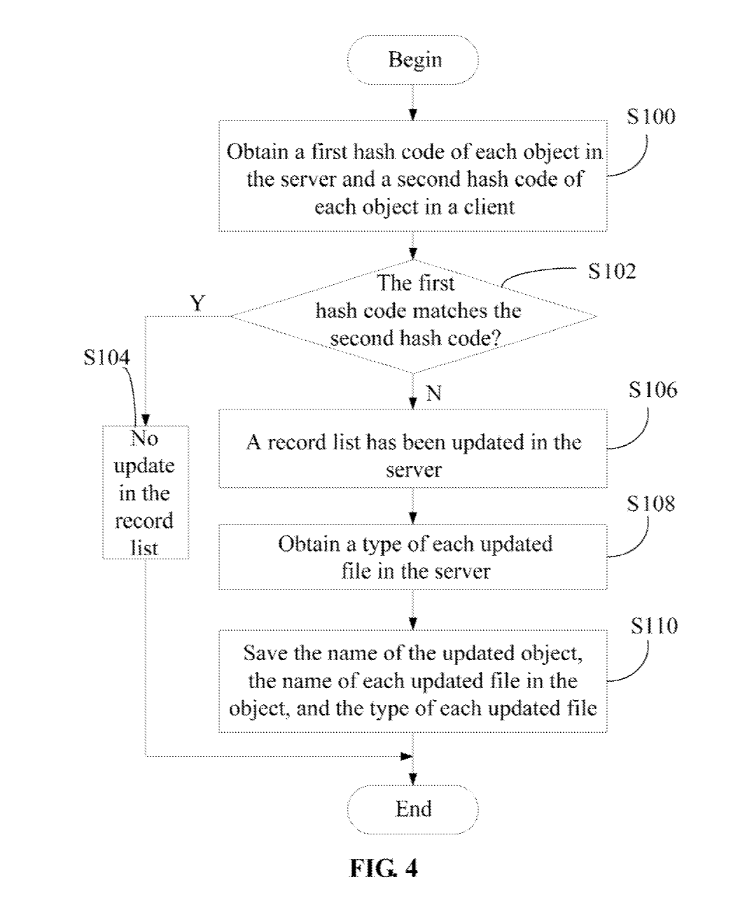

The monitoring module 1000 determines if the record list 20 has been updated (a detailed description is described in FIG. 4).

The synchronization module 1004 synchronizes the updated files from the server 2 to the client 1 according to the record list 20, in response to a determination that the record list 20 has been updated. In one embodiment, the synchronization module 1004 searches for the updated files in the server 2, and synchronizes the updated files from the server 2 to the client 1. The updated file in the server 2 is defined as the file which does not exist in the client 1. In other embodiment, if the name of the file in the client 1 is the same as the name of the file in the server 2, and the content of the file in the client 1 is different from the content of the file in the server 2, the file in the server 2 is also regarded as the updated file in the server 2.

The adjustment module 1004 adjusts the sync interval according to the times of updating the record list 20 and the one or more updating intervals of updating the record list 20. In one embodiment, the sync interval is adjusted to a (n+1)th updating interval of updating the record list 20, and the (n+1)th updating interval of updating the record list 20 is calculated by a formula as follows: yₙ₊₁=x₀+x₁tₙ₊₁, where

$${x}_{1} = \frac{{\sum }_{i = 1}^{n} ( {t}_{i} - \overline{t} ) ( {y}_{i} - \overline{y} )}{{\sum }_{i = 1}^{n} {( {t}_{i} - \overline{t} )}^{2}} , \\ {x}_{0} = \overline{y} - {x}_{1} \overline{t}$$

$$and$$

$$\overline{t} = \frac{{\sum }_{i = 1}^{n} {t}_{i}}{n} ,$$

yₙ₊₁ represents the (n+1)th updating interval of updating the record list 20, tₙ₊₁ represents the (n+1)th time of updating the record list 20, tᵢ represents the (i)th time of updating the record list 20, t̅ represents an average of times of updating the record list 20, yᵢ represents an (i)th updating interval of updating the record list 20, y̅ represents an average of the updating interval of updating the record list 20, and n is a natural number (e.g., 1, 2, 3, . . . ).

The adjustment module 1004 adjusts the sync interval according to a predetermined weight in response to a determination that the record list 20 has not been updated. In one embodiment, the adjustment module 1004 adjusts the sync interval according to the predetermined weight using a formula as following: yₙ₊₁=w₀y₀, where yₙ₊₁ represents the adjusted sync interval, w₀ represents the weight predetermined by a user and y₀ represents the original sync interval predetermined by a user. Additionally, both w₀ and y₀ are the constants, for example, w₀ may be predetermined as a digit 2 and the y₀ may be predetermined as 10 seconds, and the adjusted sync interval is 20 seconds.

The updating module 1006 updates the task scheduler 102 according to the adjusted sync interval. In one embodiment, the updating module 1006 inserts the adjusted sync interval into the task scheduler 102.

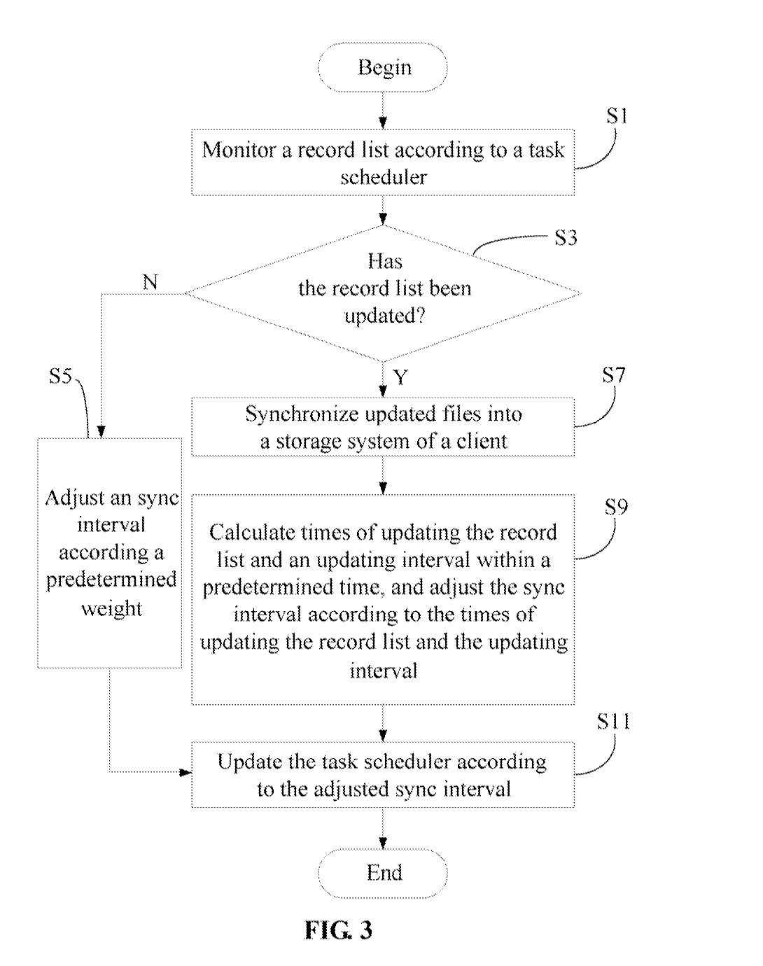

FIG. 3 is a flowchart of one embodiment of a file synchronization method. Depending on the embodiment, additional steps may be added, others deleted, and the ordering of the steps may be changed.

In step S1, the monitoring module 1000 monitors a record list 20 according to a task scheduler 102. In one embodiment, the task scheduler 102 stores a sync interval (e.g., ten seconds), and the monitoring module 1000 monitors the record list 20 at the sync intervals (e.g., every ten seconds).

In step S3, the monitoring module 1000 determines if the record list 20 has been updated (a detailed description is described in FIG. 4). If the record list 20 has been updated, the procedure goes to the step S7. Otherwise, if the record list 20 has not been updated, the procedure goes to the step S5.

In step S5, the adjustment module 1004 adjusts the sync interval according to a predetermined weight in response to a determination that the record list 20 has not been updated. Then, the procedure goes to step S11. In one embodiment, the adjustment module 1004 adjusts the sync interval according to the predetermined weight using the formula yₙ₊₁=w₀y₀ as mentioned above. For example, if w₀ is predetermined as a digit 2 and y0 is predetermined as 10 seconds, and the adjusted sync interval is adjusted to 20 seconds.

In step S7, the synchronization module 1004 synchronizes the updated files from the server 2 to the client 1 according to the record list 20. For example, as shown in FIG. 5, if the name of one file in the object A has been updated in the server 2, and the synchronization module 1004 synchronizes the updated file in the object A from the server 2 to the client 1. Additionally, the synchronization module 1004 also synchronizes the object A from the server 2 to the client 1.

In step S9, the he adjustment module 1004 adjusts the sync interval according to the number of times of updating the record list 20 and the one or more updating intervals. In one embodiment, the sync interval is adjusted to a (n+1)th updating interval of updating the record list 20, and the (n+1)th updating interval of updating the record list 20 is calculated by a formula yₙ₊₁=x₀+x₁tₙ₊₁ as mentioned above. One example of a table for showing nine times of updating the record list 20 is shown as follows:

| (i) | (ti) | (yᵢ) | tᵢ* = tᵢ − t̅ | yᵢ* = yᵢ − y̅ | tᵢ*yᵢ* | tᵢ*tᵢ* | yᵢ*yᵢ* |
|---|---|---|---|---|---|---|---|
| 1 | 1 | 210 | −4 | 59.11111111 | −236.444 | 16 | 3494.123 |
| 2 | 2 | 190 | −3 | 39.11111111 | −117.333 | 9 | 1529.679 |
| 3 | 3 | 181 | −2 | 30.11111111 | −60.2222 | 4 | 906.679 |
| 4 | 4 | 180 | −1 | 29.11111111 | −29.1111 | 1 | 847.4568 |
| 5 | 5 | 150 | 0 | −0.888888889 | 0 | 0 | 0.790123 |
| 6 | 6 | 125 | 1 | −25.88888889 | −25.8889 | 1 | 670.2346 |
| 7 | 7 | 115 | 2 | −35.88888889 | −71.7778 | 4 | 1288.012 |
| 8 | 8 | 105 | 3 | −45.88888889 | −137.667 | 9 | 2105.79 |
| 9 | 9 | 102 | 4 | −48.88888889 | −195.556 | 16 | 2390.123 |
| Σ | 45 | 1358 | | | −874 | 60 | 13232.9 |

According to the above table and the formula as mentioned above, t̅=5, y̅=150.8888889, x₁=14.56667, x₀=223.7222389, and a tenth updating interval of updating the record list 20 is calculated as yₙ₊₁=x₀x₁tₙ₊₁=223.7222389−14.56667*10=78.05554. The sync interval is adjusted to 78.05554 seconds.

In step S11, the updating module 1006 updates the task scheduler 102 according to the adjusted sync interval.

FIG. 4 is a detailed description of one step S3 in FIG. 3 of one embodiment for determining that the record list 20 has been updated.

In step S100, the monitoring module 1000 obtains a first hash code of each object in the server 2 and a second hash code of each object in the client 1, and compare the first hash code of each object with the hash code of each object according to the name of the object. For example, as shown in FIG. 5, the monitoring module 1000 searches for the name of the object A in the server 2 and the client 1, and compares the first hash code of the object A in the server 2 with the second hash code of the object A in the client 1.

In step S102, the monitoring module 100 determines if each first hash code matches the second hash code corresponding to the first hash code. In one embodiment, if each first hash code matches the second hash code corresponding to the first hash code, the procedure goes to step S104, the monitoring module 100 determines that the record list 20 has not been updated. Then, the procedure ends. Otherwise, if at least one first hash code does not match the second hash code corresponding to the first hash code, the procedure goes to step 106.

In step S04, the monitoring module 100 determines that the record list 20 has been updated.

In step S108, the monitoring module 100 obtains a type of each updated file in the record list. The type of each updated file may be, but is not limited to, an uploading type, a deleting type and a downloading type. The uploading type indicates that the file has been uploaded into the server 2, the deleting type indicates that the file has been deleted from the server 2, the downloading type indicates that the file has been downloaded from the server 2.

In step S110, the monitoring module 100 saves the name of each updated object, the name of each updated file in the object, and the type of each updated file into the record list 20.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A client in electronic communication with a server, comprising:
at least one processor;
a task scheduler, wherein the task scheduler stores a sync interval; and
a storage system that stores one or more programs, when executed by the at least one processor, cause the at least one processor to perform a file synchronization method, the method comprising:
monitoring a record list stored in the server according to the sync interval, wherein the record list comprises times of updating the record list and one or more updating intervals of updating the record list;
determining whether the record list has been updated;
synchronizing updated files from the server to the client, in response to a determination that the record list has been updated;
adjusting the sync interval according to the times of updating the record list and the one or more updating intervals of the updating the record list; and
updating the task scheduler according to the adjusted sync interval.

2. The client of claim 1, wherein the sync interval is adjusted to an (n+1)th updating interval of updating the record list and the (n+1)th updating interval of updating the record list 20 is calculated by a formula yₙ₊₁=x₀+x₁tₙ₊₁, wherein
$${x}_{1} = \frac{{\sum }_{i = 1}^{n} ( {t}_{i} - \overline{t} ) ( {y}_{i} - \overline{y} )}{{\sum }_{i = 1}^{n} {( {t}_{i} - \overline{t} )}^{2}} , \\ {x}_{0} = \overline{y} - {x}_{1} \overline{t} , \\ \overline{t} = \frac{{\sum }_{i = 1}^{n} {t}_{i}}{n} ,$$
yₙ₊₁ represents the (n+1)th updating interval of updating the record list, tₙ₊₁ represents the (n+1)th time of updating the record list, tᵢ represents the (i)th time of updating the record list, t̅ represents an average of times of updating the record list, yᵢ represents an (i)th updating interval of updating the record list and y̅ represents an average of the updating interval of updating the record list, and n is a natural number.

3. The client of claim 1, wherein the sync interval is adjusted according to a predetermined weight in response to a determination that the record list has not been updated, and the sync interval is adjusted according to the predetermined weight using a formula yₙ₊₁=w₀y₀, wherein yₙ₊₁represents the adjusted sync interval, w₀ represents the weight, and y₀ represents an original sync interval.

4. The client of claim 1, wherein a method of determining whether the record list has been updated comprising:
obtaining a first hash code of each object in the server and a second hash code of each object in the client, and comparing the first hash code of each object with the hash code of each object according to the name of each object; and
determining whether the first hash code of each object matches the second hash code of the object;
determining that the record list has been updated, when the first hash code of any object does not match the second hash code of the object; and
determining that the record list has not been updated, when the first hash code of each object matches the second hash code of the object.

5. The client of claim 4, further comprising:
obtaining a type of each updated file in the record list; and
saving a name of each updated object, a name of each updated file in the object, and the type of each updated file into the record list.

6. The client of claim 5, wherein the type of each updated file is selected from a group consisting of an uploading type, a deleting type and a downloading type.

7. A file synchronization method implemented by a client, the client in electronic communication with a server, the client stores a task scheduler, wherein the task scheduler stores a sync interval, the method comprising:
monitoring a record list stored in the server according to the sync interval, wherein the record list comprises times of updating the record list and one or more updating intervals of updating the record list;
determining whether the record list has been updated;
synchronizing updated files from the server to the client, in response to a determination that the record list has been updated;
adjusting the sync interval according to the times of updating the record list and the one or more updating intervals of the updating the record list; and
updating the task scheduler according to the adjusted sync interval.

8. The method of claim 7, wherein the sync interval is adjusted to an (n+1)th updating interval of updating the record list and the (n+1)th updating interval of updating the record list 20 is calculated by a formula yₙ₊₁=x₀+x₁tₙ₊₁, wherein
$${x}_{1} = \frac{{\sum }_{i = 1}^{n} ( {t}_{i} - \overline{t} ) ( {y}_{i} - \overline{y} )}{{\sum }_{i = 1}^{n} {( {t}_{i} - \overline{t} )}^{2}} , \\ {x}_{0} = \overline{y} - {x}_{1} \overline{t}$$
$$and$$
$$\overline{t} = \frac{{\sum }_{i = 1}^{n} {t}_{i}}{n} ,$$
yₙ₊₁ represents the (n+1)th updating interval of updating the record list, tₙ₊₁ represents the (n+1)th time of updating the record list, tᵢ represents the (i)th time of updating the record list, t̅ represents an average of times of updating the record list, yᵢ represents an (i)th updating interval of updating the record list and y̅ represents an average of the updating interval of updating the record list, and n is a natural number.

9. The method of claim 7, wherein the sync interval is adjusted according to a predetermined weight in response to a determination that the record list has not been updated, and the sync interval is adjusted according to the predetermined weight using a formula yₙ₊₁=w₀y₀, wherein yₙ₊₁ represents the adjusted sync interval, w₀ represents the weight and the y₀ represents an original sync interval.

10. The method of claim 7, wherein a method of determining if the record list has been updated comprising:
obtaining a first hash code of each object in the server and a second hash code of each object in the client, and comparing the first hash code of each object with the hash code of each object according to the name of each object; and
determining whether the first hash code of each object matches the second hash code of the object;
determining that the record list has been updated, when the first hash code of any object does not match the second hash code of the object; and
determining that the record list has not been updated, when the first hash code of each object matches the second hash code of the object.

11. The method of claim 10, further comprising:
obtaining a type of each updated file in the record list; and
saving a name of each updated object, a name of each updated file in the object, and the type of each updated file into the record list.

12. The method of claim 11, wherein the type of each updated file is selected from a group consisting of an uploading type, a deleting type and a downloading type.

13. A non-transitory computer-readable medium having stored thereon instructions that, when executed by a client, the client in electronic communication with a server, causing the client to perform a file synchronization method, the client stores a task scheduler, wherein the task scheduler stores a sync interval, the method comprising:
monitoring a record list stored in the server according to the sync interval, wherein the record list comprises times of updating the record list and one or more updating intervals of updating the record list;
determining if the record list has been updated;
synchronizing updated files from the server to the client, in response to a determination that the record list has been updated;
adjusting the sync interval according to the times of updating the record list and the one or more updating intervals of the updating the record list; and
updating the task scheduler according to the adjusted sync interval.

14. The non-transitory computer-readable medium of claim 13, wherein the sync interval is adjusted to a (n+1)th updating interval of updating the record list and the (n+1)th updating interval of updating the record list 20 is calculated by a formula yₙ₊₁x₀x₁tₙ₊₁, wherein
$${x}_{i} = \frac{{\sum }_{i = 1}^{n} ( {t}_{i} - \overline{t} ) ( {y}_{i} - \overline{y} )}{{\sum }_{i = 1}^{n} {( {t}_{i} - \overline{t} )}^{2}} , \\ {x}_{0} = \overline{y} - {x}_{1} \overline{t}$$
$$and$$
$$\overline{t} = \frac{{\sum }_{i = 1}^{n} {t}_{i}}{n} , {y}_{n + 1}$$
represents the (n+1)th updating interval of updating the record list, tₙ₊₁ represents the (n+1)th time of updating the record list, tᵢ represents the (i)th time of updating the record list, t̅ represents an average of times of updating the record list, yᵢ represents an (i)th updating interval of updating the record list and y̅ represents an average of the updating interval of updating the record list.

15. The non-transitory computer-readable medium of claim 13, wherein the sync interval is adjusted according to a predetermined weight in response to a determination that the record list has not been updated, and the sync interval is adjusted according to the predetermined weight using a formula yₙ₊₁=w₀y₀, wherein yₙ₊₁ represents the adjusted sync interval, w₀ represents the weight, and y₀ represents an original sync interval.

16. The non-transitory computer-readable medium of claim 13, wherein a method of determining whether the record list has been updated comprising:
obtaining a first hash code of each object in the server and a second hash code of each object in the client, and comparing the first hash code of each object with the hash code of each object according to the name of each object; and
determining whether the first hash code of each object matches the second hash code of the object;
determining that the record list has been updated, when the first hash code of any object does not match the second hash code of the object; and
determining that the record list has not been updated, when the first hash code of each object matches the second hash code of the object.

17. The non-transitory computer-readable medium of claim 16, further comprising:
obtaining a type of each updated file in the record list; and
saving a name of each updated object, a name of each updated file in the object, and the type of each updated file into the record list.

18. The non-transitory computer-readable medium of claim 17, wherein the type of each updated file is selected from a group consisting of an uploading type, a deleting type and a downloading type.
